(19) United States
(12) Patent Application Publication
(10) Pub. No.: US 2024/0239605 A1
(43) Pub. Date: Jul. 18, 2024

(54) METHOD AND APPARATUS FOR IDENTIFYING ITEMS IN MASS SHELVING ENVIRONMENTS

(71) Applicant: Johnathan Thomas Brand, Sherrodsville, OH (US)

(72) Inventor: Johnathan Thomas BRAND, Sherrodsville, OH (US)

(21) Appl. No.: 18/411,137

(22) Filed: Jan. 12, 2024

Related U.S. Application Data
(60) Provisional application No. 63/576,425, filed on Jan. 12, 2023.

(51) Int. Cl. B65G 1/137; G06Q 10/087

(52) U.S. Cl. CPC B65G 1/1371; G06Q 10/087

(57) ABSTRACT

An identification system for a mass storage system to automatically indicate locations of selected items. Identification system may include a user initiable microcontroller. Identification system may also include a computer readable storage device that is in logical communication with the user initiable microcontroller and configured to store a computer usable media for indicating any item from a predetermined amount of items stored in a plurality of shelving units. Identification system may also include at least one set of indicators electrically connected with the user initiable microcontroller and operably engaged with the shelving units of the plurality of shelving units. The user initiable microcontroller is configured to automatically indicate at least one location of a selected item, via the at least one set of indicators, in any shelving unit of the plurality of shelving units in response to at least one identification code executed on the user initiable microcontroller.

### REFERENCE TO RELATED APPLICATIONS

This application claims the benefit of U.S. Provisional Application Ser. No. 63/576,425, filed on Jan. 12, 2023; the disclosure of which is incorporated herein by reference.

### TECHNICAL FIELD

The present disclosure is directed to systems and methods of indicating and identifying items from a mass storage environment.

### BACKGROUND ART

In a retail setting, a warehouse setting, or other similar settings, goods or items are often stored on shelving units or rack structures in an organized manner for later retrieval. When a purchasing order is received, an employee or picker travels throughout the retail store or warehouse to retrieve the item or items listed on the order form. However, such finding and retrieval of an item may become time consuming and difficult based on the overall size of the retail setting and/or warehouse setting. With such difficulty, mistakes and/or errors are made by the employee or picker resulting in costs to the company and facility due to these errors (i.e., incorrect items handed to or shipped to the customers, inventory inaccuracies in the shelving system, additional labor costs to correct improper item identification, and loss of customer satisfaction from receiving incorrect items).

To combat this issue, organizational systems may be generally used to assist in preventing such faults or errors by the employee or picker. In one instance, layouts of the shelving units in mass storage environment (i.e., maps and/or diagrams) may be of use in order to understand where specific inventory is stored. However, in this instance, employees and pickers must still have a sufficient knowledge and memory in determining where a specific type of item may be located. Even with this knowledge, layouts of shelving units or layouts of storing items may change periodically thus resulting additional time to understand new layouts of shelving units or layouts of storing items. In another instance, product sheets of the items stored in mass storage environment may be of use in order to understand where specific inventory is stored. However, in this instance, employees and pickers are required to visually observe multiple pieces of logistical information at about the same time (e.g., the product information on the order form, the corresponding product information on the product sheet, and the product itself). With such information, employees and pickers may get distracted or read information incorrectly thus leading to errors when gather or more items from one or more shelving units.

### SUMMARY OF THE INVENTION

In one aspect, an exemplary embodiment of the present disclosure may provide an identification system for a mass storage system. The identification system includes a user initiable microcontroller. The identification system also includes a computer readable storage device in logical communication with the user initiable microcontroller and configured to store a computer usable media for indicating any item from a predetermined amount of items stored in a plurality of shelving units of the mass storage system. The identification system also includes at least one set of indicators electrically connected with the user initiable microcontroller and operably engaged with each shelf of a shelving unit of the plurality of shelving units. The user initiable microcontroller is configured to automatically indicate the at least one location of a selected item, via the at least one set of indicators, in any shelving unit of the plurality of shelving units in response to at least one identification code executed on the user initiable microcontroller.

This exemplary embodiment or another exemplary embodiment may further include that the at least one set of indicators is configured to automatically visually indicate at least one location of the selected item in any shelving unit of the plurality of shelving units in response to the at least one identification code executed on the user initiable microcontroller. This exemplary embodiment or another exemplary embodiment may further include that the at least one set of indicators comprises: a first logistic indication in response to the at least one identification code executed on the user initiable microcontroller; wherein the first logistic indication signifies a first payment state of the selected item. This exemplary embodiment or another exemplary embodiment may further include that the at least one set of indicators further comprises: a second logistic indication in response to at least another identification code executed on the user initiable microcontroller; wherein the second logistic indication signifies a second payment state of the selected item different than the first payment state indicated by the first logistic indication. This exemplary embodiment or another exemplary embodiment may further include a user interfacing device electrically connected with the user initiable microcontroller; wherein the user interfacing device is configured for executing the at least one identification code on the user initiable microcontroller to automatically indicate the at least one location of the selected item in any shelving unit of the plurality of shelving units. This exemplary embodiment or another exemplary embodiment may further include that the user interfacing device is electrically connected with the user initiable microcontroller via a wired connection or a wireless connection. This exemplary embodiment or another exemplary embodiment may further include an external computer in logical communication with the user initiable microcontroller; wherein the external computer is configured to store a second computer usable media for itemizing each item from the predetermined amount of items stored in the plurality of shelving units. This exemplary embodiment or another exemplary embodiment may further include at least another set of indicators electrically connected with the microcontroller and operably engaged with each shelf of a shelving unit of the plurality of shelving units; wherein the user initiable microcontroller is configured to automatically indicate the at least one location of the selected item, via the at least another set of indicators, in any shelving unit of the plurality of shelving units in response to the at least one identification code executed on the user initiable microcontroller. This exemplary embodiment or another exemplary embodiment may further include that each item of the predetermined amount of items is positioned between the at least one set of indicators and the at least another set of indicators. This exemplary embodiment or another exemplary embodiment may further include a power source electrically connected with one of the at least one set of indicators and the at least another set of indicators for providing electrical power to the at least one set of indicators and the at least another set of indicators.

In another aspect, an exemplary embodiment of the present disclosure may provide a method of indicating a selected item in a mass shelving environment. The method includes steps of initiating an identification system of the mass shelving environment; executing at least one identification code on a user initiable microcontroller of the identification system; retrieving information of the at least one identification code, via the user initiable microcontroller, from a computer usable media stored on a computer readable storage device of the identification system; sending at least one signal from the user initiable microcontroller to at least one set of indicators; and indicating the selected item in the mass shelving environment via an indicator of the at least one set of indicators.

This exemplary embodiment or another exemplary embodiment may further include that the step of indicating the selected item in the mass shelving environment via the indicator of the at least one set of indicators further includes that the selected item in the mass shelving environment is visually indicated by the indicator of the at least one set of indicators. This exemplary embodiment or another exemplary embodiment may further include a step of emitting a first logistic indication, via the indicator of the at least one set of indicators, in response to the at least one identification code executed on the user initiable microcontroller; wherein the first logistic indication denotes that a first payment state of the selected item. This exemplary embodiment or another exemplary embodiment may further include a step of emitting a second logistic indication, via the indicator of the at least one set of indicators, in response to the at least one identification code executed on the user initiable microcontroller; wherein the second logistic indication denotes that a second payment state of the selected item different than the first payment state denoted by the first logistic indication. This exemplary embodiment or another exemplary embodiment may further include a step of inputting the at least one identification code on the user initiable microcontroller via a user interfacing device of the identification system. This exemplary embodiment or another exemplary embodiment may further include a step of connecting the user interfacing device with the user initiable microcontroller by one of a wired connection or a wireless connection. This exemplary embodiment or another exemplary embodiment may further include a step of itemizing each item from a predetermined amount of items stored in the plurality of shelving units by an external computer of the identification system. This exemplary embodiment or another exemplary embodiment may further include steps of sending the at least one signal from the user initiable microcontroller to at least another set of indicators of the identification system; and indicating the selected item in the mass shelving environment via an indicator of the at least another set of indicators. This exemplary embodiment or another exemplary embodiment may further include that the selected item is positioned between the at least one set of indicators and the at least another set of indicators. This exemplary embodiment or another exemplary embodiment may further include a step of powering to the at least one set of indicators and the at least another set of indicators via a power source of the identification system.

### BRIEF DESCRIPTION OF THE DRAWINGS

Sample embodiments of the present disclosure are set forth in the following description, are shown in the drawings and are particularly and distinctly pointed out and set forth in the appended claims.

FIG. 1 is a diagrammatic view of a mass storage system including at least one shelving unit and an identification system.

FIG. 2 is a diagrammatic view of the identification system shown in FIG. 1.

FIG. 3 is a diagrammatic view of an alternative identification system.

FIG. 4 is a diagrammatic view of another alternative identification system.

FIG. 5 is an operational flowchart of operating the identification system of the mass storage system.

FIG. 6A is an operational view of the identification system following the operational flowchart shown in FIG. 5, wherein an indicator of at least one set of indicators of the identification system indicates a first bay of the shelving unit with a first logistic indication.

FIG. 6B is another operational view similar to FIG. 6A, but another indicator of the at least one set of indicators of the identification system identifies a second bay of the shelving unit with a second logistic indication.

FIG. 6C is another operational view similar to FIG. 6B, but yet another indicator of the at least one set of indicators of the identification system identifies a third bay of the shelving unit with a third logistic indication.

FIG. 7 is a method flowchart of indicating a selected item in a mass shelving environment.

FIG. 8 is another operational flowchart of operating the identification system of the mass storage system.

FIG. 9A is an operational view of the identification system following the operational flowchart shown in FIG. 8, wherein a user inputs a voice command into a user interfacing device of the identification system.

FIG. 9B is another operational view that continues from FIG. 9A, wherein a selected item is generated on the user interfacing device based on the voice command performed by the user.

FIG. 9C is another operational view that continues from FIG. 9B, but an indicator of at least one set of indicators of the identification system indicates a first bay of the shelving unit with a first logistic indication based on the voice command performed by the user.

FIG. 10A is an operational view of the identification system following the operational flowchart shown in FIG. 8, wherein the user scans an identification code with a preexisting scanner device and sends such information of the identification code to a user interfacing device

FIG. 10B is another operational view that continues from FIG. 9A, wherein a selected item is generated on the user interfacing device based on the identification code scanned by the preexisting scanner device.

Similar numbers refer to similar parts throughout the drawings.

### DETAILED DESCRIPTION

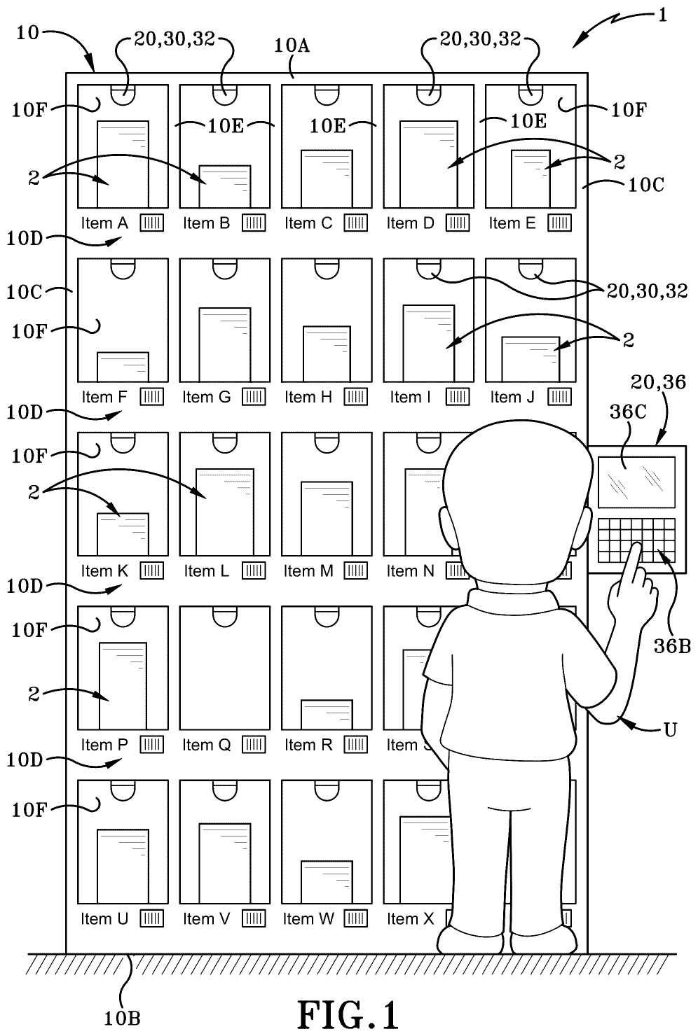

FIG. 1 illustrates a mass storage system, generally referred to as reference numeral 1, for storing and organizing a plurality of items 2. It should be understood that FIG. 1 (as well as other figures herein) merely illustrates a single shelving unit operably engaged with an identification system of mass storage system 1 for ease of explaining and illustrating the use of mass storage system 1 for automatically indicating selected items to a user of the mass storage system 1. While not illustrated herein, mass storage system 1 may include one or more shelving units operably engaged with an identification system for automatically indicating selected items to a user of the mass storage system 1. Such components and systems of mass storage system 1 are described in greater detail below.

Mass storage system 1 includes a plurality of shelving units 10 configured to store the plurality of items 2. As best seen in FIG. 1, a single shelving unit 10 is illustrated herein for ease of explaining and illustrating the use of mass storage system 1. Each shelving unit 10 may include a top wall 10A, a bottom wall 10B opposite to the top wall 10A, and a vertical direction defined therebetween. Each shelving unit 10 may also include a pair of exterior upright walls 10C extending between the top wall 10A and the bottom wall 10B along the vertical direction of shelving unit 10. Shelving unit 10 may also include a set of shelves 10D that extends between the pair of exterior upright walls 10C where each shelf of the set of shelves 10D is parallel with the top wall 10A and the bottom wall 10B. Shelving unit 10 may also include a set of interior upright walls 10E that extends between each shelf 10D of the set of shelves 10D provided in shelving unit 10. Each interior upright walls of the set of interior upright walls 10E is also parallel with the pair of exterior upright walls 10C.

Still referring to FIG. 1, shelving unit 10 may also define a set of bays or compartments 10F. In one instance, at least one bay of the set of bays 10F may be defined by one of the top wall 10A and the bottom wall 10B, one of the exterior upright walls from the pair of exterior upright walls 10C, a shelf 10D, and one of the interior upright walls from the set of interior upright walls 10E. In another instance, at least another bay of the set of bays 10F may be defined by a first shelf of the set of shelves 10D, a second shelf of the set of shelves 10D positioned vertical below the first shelf, and two interior upright walls 10E from the set of interior upright walls 10E. In the illustrated embodiment, shelving unit 10 defines twenty-five bays 10F. In other exemplar embodiments, any suitable number of bays 10F may be defined in the shelving unit 10 at any suitable shape, size, or configuration based on the items be housed and stored by the shelving unit 10.

It should be appreciated that while shelving unit 10 is described and illustrated herein, any suitable shelving unit may be used for housing and storing a plurality of items and/or items in a mass storage system. Examples of suitable shelving unit that may be used in the mass storage system for housing and storing a plurality of items include fixed bracket shelf units or suspended shelf units, floating shelf units, built-in shelf units, corner shelf units, rotating shelf units, hanging shelf units, free-standing shelf units, adjustable slotted shelf units, steel shelf units, rivet shelf units, cantilever shelf units, pallet rack or bulk rack shelf units, wire shelf units, boltless or clipless shelf units, and other various types of shelving unit for housing and storing a plurality of items in a mass storage system.

Mass storage system 1 also includes an identification system 20 that operably engages with each shelving unit of the plurality of shelving units 10. As described in more detail below, identification system 20 is configured to automatically indicate at least one location of a selected item in a bay 10F of any shelving unit of the plurality of shelving units 10 in response to at least one identification code executed on the identification system 20. More particularly, the at least one set of indicators is configured to automatically visually indicate at least one location of the selected item in a bay 10F of any shelving unit of the plurality of shelving units 10 in response to at least one identification code executed on the identification system 20. Such components and devices of identification system 20 is described in more detail below.

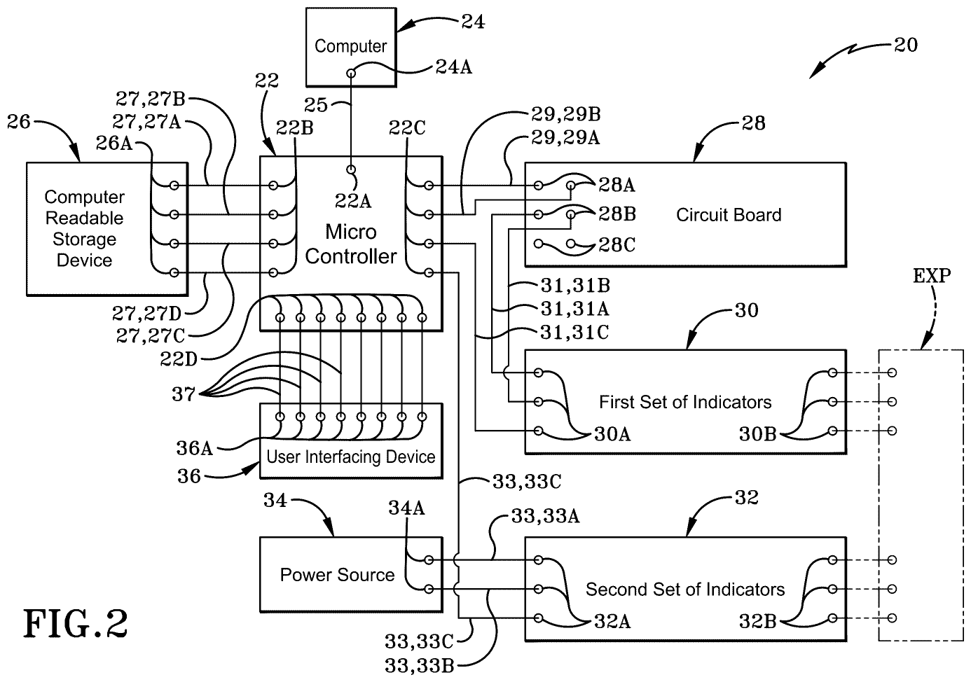

Identification system 20 may include a user initiable microcontroller 22. As described in greater detail below, user initiable microcontroller 22 is configured to control automatic indication of at least one location of a selected item in a bay 10F of any shelving unit of the plurality of shelving units 10 in response to at least one identification code executed on the user initiable microcontroller 22 by a user of identification system 20. In the illustrated embodiment, user initiable microcontroller 22 may include one or more sets of input and output connections (or I/O connections) for electrically connecting the user initiable microcontroller 22 with other various electrical components and devices in the identification system 20. As best seen in FIG. 2, user initiable microcontroller 22 includes a first set of input and outputs (I/Os) 22A, a second set of I/O connections 22B, a third set of I/O connections 22C, and a fourth set of I/O connections 22D for electrically connecting the user initiable microcontroller 22 with other various electrical components and devices in the identification system 20.

It should be appreciated that user initiable microcontroller 22 may be any commercially-available user initiable microcontroller 22 that is configured to control automatic indication of a selected item in a bay 10F defined of any shelving unit of the plurality of shelving units 10 in response to at least one identification code executed on the user initiable microcontroller 22 by a user of identification system 20. In one instance, user initiable microcontroller may be a pinout microcontroller configured to control automatic indication of a selected item in a bay 10F of any shelving unit of a plurality of shelving units in response to at least one identification code executed on the pinout microcontroller by a user of identification system.

Identification system 20 may also include an external computer 24 that operably connects with the user initiable microcontroller 22. As best seen in FIG. 2, external computer 24 may include at least one I/O connection 24A that is suitable for operably connecting the external computer 24 with the user initiable microcontroller 22 via an electrical connection. In the illustrated embodiment, the user initiable microcontroller 22 and the external computer 24 may communicate with one another via an electrical connection 25 which connects with the first set of I/O connections 22A of the user initiable microcontroller 22 and the at least one I/O connection 24A of the external computer 24. In this illustrated embodiment, the electrical connection 25 between the user initiable microcontroller 22 and the external computer 24 may be a Universal Serial Bus (or USB) connection. It should be appreciated that user initiable microcontroller 22 and external computer 24 may be electrically connected with one another via a wired connection (shown in FIG. 2) or by a wireless connection using commercially available protocols and devices to enable wireless communication between user initiable microcontroller 22 and external computer 24.

During operation, external computer 24 may be used for programming and/or configuring the user initiable microcontroller 22 to automatically indicate at least one location of a selected item in any shelving unit of the plurality of shelving units 10 in response to at least one identification code executed on the user initiable microcontroller 22. External computer 24 may also include a computer readable storage media or program that itemizes each item from a predetermined amount of items stored in the plurality of shelving units 10; such computer readable storage media may be relayed to the user initiable microcontroller 22 for itemizing and cataloging items and items 2 housed in the shelving units 10.

Identification system 20 may also include a computer readable storage device 26 that operably connects with the user initiable microcontroller 22. As best seen in FIG. 2, computer readable storage device 26 may include a set of I/O connections 26A that is suitable for operably connecting the computer readable storage device 26 with the user initiable microcontroller 22 via a set of electrical connections. In the illustrated embodiment, the user initiable microcontroller 22 and the computer readable storage device 26 may communicate with one another via a set of electrical connections 27 connecting with the second set of I/O connections 22B of the user initiable microcontroller 22 and the set of I/O connections 26A of the computer readable storage device 26.

In the illustrated embodiment, the set of electrical connections 27 may enable specific electrical signals and/or data to be sent between the user initiable microcontroller 22 and the computer readable storage device 26. In one instance, a first electrical connection 27A of the set of electrical connections 27 connecting the user initiable microcontroller 22 and the computer readable storage device 26 with one another is configured for delivering a common collector voltage between the user initiable microcontroller 22 and the computer readable storage device 26. In another instance, a second electrical connection 27B of the set of electrical connections 27 connecting the user initiable microcontroller 22 and the computer readable storage device 26 with one another is configured for delivering a serial clock signal between the user initiable microcontroller 22 and the computer readable storage device 26. In yet another instance, a third electrical connection 27C of the set of electrical connections 27 connecting the user initiable microcontroller 22 and the computer readable storage device 26 with one another is configured for delivering a serial data signal between the user initiable microcontroller 22 and the computer readable storage device 26. In yet another instance, a fourth electrical connection 27D of the set of electrical connections 27 connecting the user initiable microcontroller 22 and the computer readable storage device 26 with one another is configured for delivering a ground connection between the user initiable microcontroller 22 and the computer readable storage device 26.

It should be appreciated that user initiable microcontroller 22 and computer readable storage device 26 may be electrically connected with one another via a wired connection (shown in FIG. 2) or by a wireless connection using commercially available protocols and devices to enable wireless communication between user initiable microcontroller 22 and computer readable storage device 26.

Computer readable storage device 26 described and illustrated herein may be an electrically erasable programmable read-only memory (or EEPROM) device or flash memory device configured to store data that can be erased and reprogrammed for one or more operational reasons. During operation, a user of identification system 20 may load or program one or more identification codes on the computer readable storage device 26 that designate each bay of the set of bays 10F defined in the shelving unit 10 that store a specific item 2. In one instance, these identification codes programmed on the computer readable storage device 26 may be keystrings or keystrokes that are executed on the user initiable microcontroller 22 for automatically indicating one or more bays in the set of bays 10F in any shelving unit of the plurality of shelving units 10 when finding specific items 2. A user of identification system 20 may also erase one or more identification codes on the computer readable storage device 26 and reprogram the one or more identification codes on the computer readable storage device 26 to reassign one or more bays of the set of bays 10F defined in the shelving unit 10 that store new items 2. It should also be appreciated that the one or more identification codes programmed on the computer readable storage device 26 may also include additional logistic information associated to a specific bay 10F, including the payment state of the item 2 stored in the specific bay 10F, which is described in more detail below.

Identification system 20 may also include a breadboard or an electrical circuit board 28 that operably connects the user initiable microcontroller 22 with other electrical components and devices provided in identification system 20. As best seen in FIG. 2, circuit board 28 may include a first set of I/O connections 28A that is suitable for operably connecting the user initiable microcontroller 22 with other electrical components and devices provided in identification system 20. In the illustrated embodiment, the user initiable microcontroller 22 and the circuit board 28 may communicate with one another via a set of electrical connections 29 connecting with the third set of I/O connections 22C of the user initiable microcontroller 22 and the set of I/O connections 28A of the circuit board 28. Still referring to FIG. 2, the circuit board 28 may also include a second set of I/O connections 28B that is suitable for operably connecting with at least one set of indicators of the identification system 20, which is described in greater detail below. Still referring to FIG. 2, the circuit board 28 may also include a third set of I/O connections 28C that is suitable for operably connecting with other electrical devices for expanding identification system 20 (e.g., at least two or more sets of indicators, user initiable microcontrollers, power supplies, etc.). In this instance, the third set of I/O connections 28C is left unused.

In the illustrated embodiment, the set of electrical connections 29 may enable specific electrical signals and/or data to be sent between the user initiable microcontroller 22 and the circuit board 28. In one instance, a first electrical connection 29A of the set of electrical connections 29 connecting the user initiable microcontroller 22 and the circuit board 28 with one another is configured for delivering a ground connection between the user initiable microcontroller 22 and the circuit board 28. In another instance, a second electrical connection 29B of the set of electrical connections 29 connecting the user initiable microcontroller 22 and the circuit board 28 with one another is configured for delivering a power connection between the user initiable microcontroller 22 and the computer readable storage device 26. In this instance, the set of electrical connections 29 is providing a power source from the user initiable microcontroller 22 to the circuit board 28 so that other electrical devices connected with the circuit board 28 may be powered by user initiable microcontroller 22.

Identification system 20 may also include at least one set of indicators that electrically connects with at least one of the user initiable microcontroller 22 and the circuit board 28. In the illustrated embodiment, identification system 20 includes a first set of indicators 30 that electrically connects with the user initiable microcontroller 22 and the circuit board 28, and a second set of indicators 32 that electrically connects with the user initiable microcontroller 22. It should be appreciated that the first set of indicators 30 and the second set of indicators 32 are substantially similar to one another and are similarly operated by the user initiable microcontroller 22. Inasmuch as the first set of indicators 30 and the second set of indicators 32 are substantially similar to one another, the following description will relate to the first set of indicators 30 for brevity. It should be appreciated that the description of the first set of indicators 30 applies substantially similar to the second set of indicators 32.

With respect to the first set of indicators 30, first set of indicators 30 may include at least one set of I/O connections 30A for enabling electrical connection between the user initiable microcontroller 22 and the circuit board 28. As best seen in FIG.2, first set of indicators 30 may include a first set of I/O connections 30A that is suitable for operably connecting the first set of indicators 30 with the user initiable microcontroller 22 and circuit board 28 provided in identification system 20. Still referring to FIG.2, first set of indicators 30 may also include a second set of I/O connections 30B that is suitable for operably connecting the first set of indicators 30 with additional electrical components or devices provided in identification system 20. For example, the second set of I/O connection 30B may be used for operably connecting additional sets of indicators or other identification devices (see dot-dot-dashed box denoted “EXP” in FIG.2) to expand the identification system 20. In the illustrated embodiment, the user initiable microcontroller 22, the circuit board 28, and the first set of indicators 30 may communicate with and/or deliver power between one another via a set of electrical connections 31 connecting with the third set of I/O connections 22C of the user initiable microcontroller 22, the second set of I/O connections 28B of the circuit board 28, and the first set of I/O connections 30A of the first set of indicators 30.

In the illustrated embodiment, the set of electrical connections 31 may enable specific electrical signals and/or data to be sent between the user initiable microcontroller 22, the circuit board 28, and the first set of indicators 30. In one instance, a first electrical connection 31A of the set of electrical connections 31 connecting the circuit board 28 and the first set of indicator 30 with one another is configured for delivering a ground connection between the circuit board 28 and the first set of indicator 30. In another instance, a second electrical connection 31B of the set of electrical connections 31 connecting the circuit board 28 and the first set of indicator 30 with one another is configured for delivering a power connection between the circuit board 28 and the first set of indicator 30. In yet another instance, a third electrical connection 31C of the set of electrical connections 31 connecting the user initiable microcontroller 22 and the first set of indicator 30 with one another is configured for sending data from the user initiable microcontroller 22 to the first set of indicator 30 for exciting a desired indicator of the first set of indicators 30 during an identification operation, which is described in further detail below.

As discussed above, the second set of indicators 32 is substantially similar to the first set of indicators 30. As such, a first set of I/O connections 32A and a second set of I/O connections 32B of the second set of indicators 32 are substantially similar to the first set of I/O connections 30A and the second set of I/O connections 30B of the first set of indicators 30.

However, such use of the first set of I/O connections 32A and the second set of I/O connections 32B of the second set of indicators 32 are discussed in greater detail below. As best seen in FIG. 2, the first set of I/O connections 32A is suitable for operably connecting the second set of indicators 32 with the user initiable microcontroller 22 and a power source 34 provided in identification system 20. Still referring to FIG.2, the second set of I/O connections 32B is suitable for operably connecting the second set of indicators 32 with additional electrical components or devices provided in identification system 20. For example, the second set of I/O connection 32B may be used for operably connecting additional sets of indicators or other identification devices (see dot-dot-dashed box denoted “EXP” in FIG. 2) to expand the identification system 20. In the illustrated embodiment, the user initiable microcontroller 22, the second set of indicators 32, and the power source 34 may communicate with and/or deliver power between one another via a set of electrical connections 33 connecting with the third set of I/O connections 22C of the user initiable microcontroller 22, the first set of I/O connections 32A of the second set of indicators 32, and a set of I/O connections 34A for power source 34.

In the illustrated embodiment, the set of electrical connections 33 may enable specific electrical signals and/or information to be sent between the user initiable microcontroller 22, the second set of indicators 32, and the power source 34. In one instance, a first electrical connection 33A of the set of electrical connections 33 connecting the power source 34 and the second set of indicator 32 with one another is configured for delivering a ground connection between the power source 34 and the second set of indicator 32. In another instance, a second electrical connection 33B of the set of electrical connections 33 connecting power source 34 and the second set of indicator 32 with one another is configured for delivering a power connection between power source 34 and the second set of indicator 32. In yet another instance, a third electrical connection 33C of the set of electrical connections 33 connecting the user initiable microcontroller 22 and the second set of indicator 32 with one another is configured for sending data from the user initiable microcontroller 22 to the second set of indicator 32 for exciting a desired indicator of the second set of indicators 32 during an identification operation, which is described in further detail below.

In the illustrated embodiment, the first set of indicators 30 and a second set of indicators 32 are sets of light sources that visually indicate or illuminate a selected bay from the set of bays 10F defined in the shelving unit 10 to identify a selected item 2. In this instance, the first set of indicators 30 and the second set of indicators 32 may be any suitable light sources or illuminating elements that are configured to illuminate a selected bay from the set of bays 10F defined in the shelving unit 10 to identify a selected item 2, including electric discharge or electrical energy lights or electroluminescence lights (e.g., light emitting diodes (LED)).

While the first set of indicators 30 and a second set of indicators 32 are sets of light sources, it should be appreciated that any suitable indicating devices and/or elements may be used for the first set of indicators 30 and the second set of indicators 32 for indicating a selected item 2 during identification operations. In one example, a first set of indicators and a second set of indicators may be sets of audio devices (e.g., audio speakers) that audibly indicate a selected bay from the set of bays 10F defined in the shelving unit 10 to identify a selected item 2. In another instance, both audible and visual indications may be used together to indicate a selected bay from the set of bays 10F defined in the shelving unit 10 to identify a selected item 2.

An indicator in one or both of the first set of indicators 30 and the second set of indicators 32 may be positioned in a respective bay of the set of bays 10F defined in the shelving unit 10. As best seen in FIG. 2, each indicator in the first set of indicators 30 is located at a top position inside of each bay of the set of bays 10F defined in the shelving unit 10. Similarly, each indicator in the second set of indicators 32 is located at a top position inside the top of each bay of the set of bays 10F defined in the shelving unit 10. In one example, the item 2 may be positioned inside of a bay of the set of bays 10F and positioned between an indicator of the first set of indicators 30 and an indicator of the second set of indicators 32. Such positioning and use of an indicator of the first set of indicators 30 and an indicator of the second set of indicators 32 enables a user to identify the specific bay when located in front of the shelving unit 10 (as shown in FIG. 1) or located behind the shelving unit 10. In other examples, an indicator in one or both of the first set of indicators 30 and the second set of indicators 32 may be located at any suitable position inside a respective bay of the set of bays 10F while the indicator in one or both of the first set of indicators 30 and the second set of indicators 32 is still enabled to indicate a specific bay of the set of bays 10F to the user.

In the illustrated embodiment, power source 34 is electrically connected to the second set of indicators 32 for providing power to the second set of indicators 32. It should be appreciated that power source 34 may be electrically connected to any electrical component or devices currently provided in identification system 20 (including first set of indicators 32) or any electrical component or device to expand the identification system 20 (denoted as “EXP” herein). In one instance, power source 34 may be electrically connected with a plurality of indicators (similar to first and second set of indicators 30, 32) for providing power to the plurality of indicators when expanding the identification system 20 for various reasons, including the number of shelving units 10, the number of bays 10F defined in each shelving unit 10, or other various reasons of the like.

It should be appreciated that power supply 34 may be any suitable device or apparatus that provides power or electrical energy to the second set of indicators 32 as well as other devices or components currently provided in identification system 20 or subsequently provided in identification system 20 upon expansion of said identification system 20. In one instance, power supply 34 may be a portable battery that provides an electric source to the second set of indicators 32 as well as other devices or components currently provided in identification system 20 or subsequently provided in identification system 20 due to expansion. In other instances, power supply 34 may be a primary electric source installed in a building or structure (e.g., generator, power grid, wall power, etc.) where the mass storage system 1 is located to provide power to the second set of indicators 32 as well as other devices or components currently provided in identification system 20 or subsequently provided in identification system 20 due to expansion of said identification system 20.

It should be understood that the sets of electrical connections 31, 33 may be any suitable electrical connections that provide operative communication with the user initiable microcontroller 22, the circuit board 28, and the first set of indictors 30, the second set of indicators 32, and the power source 34. In one exemplary embodiment, the sets of electrical connections 31, 33 are wired connections that electrically connect the user initiable microcontroller 22, the circuit board 28, and the first set of indictors 30, the second set of indicators 32, and the power source 34 with one another. In another exemplary embodiments, the set of electrical connections 31, 33 are wireless connections that electrically connect the user initiable microcontroller 22, the circuit board 28, and the first set of indictors 30, the second set of indicators 32, and the power source 34 with one another. Except for the power connections for the first set of indictors 30 and the second set of indicators 32, the user initiable microcontroller 22 and the circuit board 28 may wirelessly communicate with the first set of indictors 30 and the second set of indicators 32 by conventional wireless communication protocols currently available at the time of this filing date or currently unavailable at the time of this filing date. Examples of suitable wireless communication protocols include, but are not limited to, Wi-Fi®, ZigBee®, MIWI, BLUETOOTH®, and other suitable communication protocols that allow the user initiable microcontroller 22, the circuit board 28, and the first set of indictors 30, and the second set of indicators 32 to wirelessly communicate with one another. With respect to power connections, each set of indicators 30, 32 (as well as indicator expansions) may be remotely powered by one or more power sources (e.g., power source 34) with the capability of expanding the indicators dictated by the implementation of such indicators.

Identification system 20 may also include a user interfacing device 36 that operably connects with the user initiable microcontroller 22. As best seen in FIG. 2, user interfacing device 36 may include a set of I/O connections 36A that is suitable for operably connecting the user interfacing device 36 with the user initiable microcontroller 22. As best seen in FIG. 2, user interfacing device 36 may also include a keypad 36B that electrically connects with the set of I/O connections 36A. With such keypad 36B, the keypad 36B enables a user of identification system 20 to interact with and execute one or more identification codes on the user initiable microcontroller 22 for enabling the identification system 20 to indicate a selected item 2 stored in a selected bay from the set of bays 10F defined in the shelving unit 10. Still referring to FIG. 2, user interfacing device 36 also includes a display screen 36C that displays one or more identification codes inputted into the user interfacing device 36 by the user.

As best seen in FIG. 1, the user initiable microcontroller 22 and the user interfacing device 36 may communicate with one another via a set of electrical connections 37 connecting with the fourth set of I/O connections 22D of the user initiable microcontroller 22 and the set of I/O connections 36A of the user interfacing device 36. In the illustrated embodiment, the set of electrical connections 37 may enable specific electrical signals and/or information to be sent between the user initiable microcontroller 22 and the user interfacing device 36.

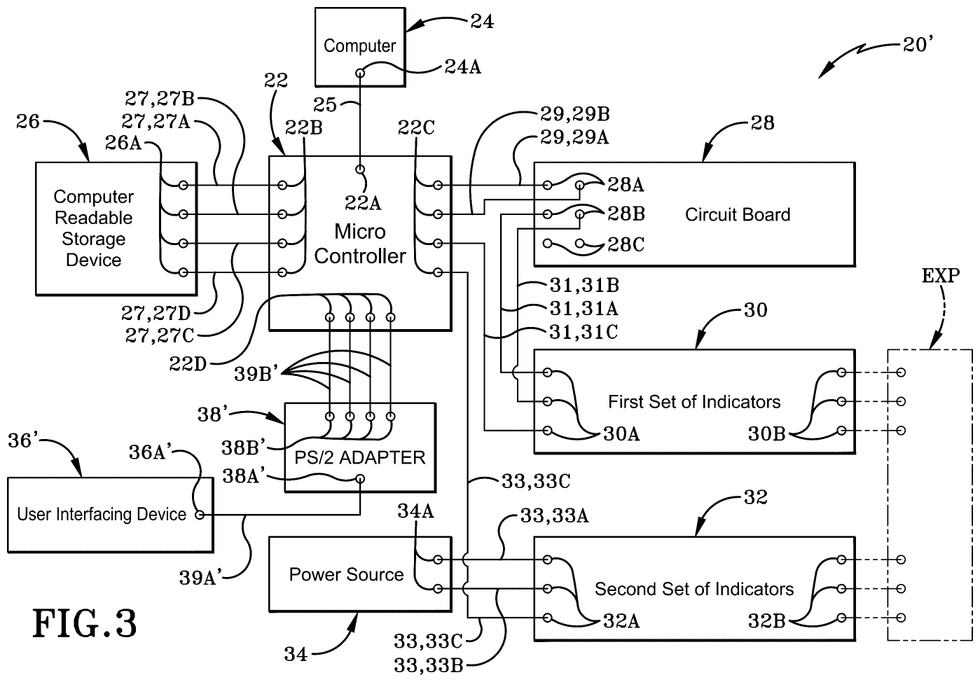

In an alternative embodiment, identification system 20 may include an alternative user interfacing device 36′ that operably connects with the user initiable microcontroller 22. As best seen in FIG. 3, user interfacing device 36′ may include an I/O connection 36A′ that is suitable for operably connecting the user interfacing device 36′ with the user initiable microcontroller 22 via an adapter 38′, which is discussed in greater detail below. As best seen in FIG. 3, user interfacing device 36′ may also include a keyboard that electrically connects with the I/O connection 36A′. With such keypad, the user interfacing device 36′ enables a user of identification system 20 to interact with and execute one or more identification codes on the user initiable microcontroller 22 to indicate a specific bay from the set of bays 10F defined in the shelving unit 10 for identifying a specific item 2. While not illustrated herein, user interfacing device 36′ may include a display screen or display monitor that displays one or more identification codes inputted into the user interfacing device 36′ by the user.

With respect to adapter 38′, adapter 38′ includes a first set of I/O connections 38A′ that enables electrical connection between the user interfacing device 36′ and the adapter 38′ (see FIG. 3). Adapter 38′ also includes a second set of I/O connections 38B′ that enables electrical connection between the user initiable microcontroller 22 and the adapter 38′ (see FIG. 3). Identification system 20 also includes a first set of electrical connections 39A′ that electrical connects the user interfacing device 36′ and the adapter 38′ with one another via the I/O connection 36A′ of the user interfacing device 36′ and the first set of I/O connections 38A′ of the adapter 38′. With such connection, the user interfacing device 36′ may communicate with the adapter 38′. Identification system 20 also includes a second set of electrical connections 39B′ that electrical connects the adapter 38′ and the user initiable microcontroller 22 with one another via the fourth set of I/O connections 22D of the user initiable microcontroller 22 and the second set of I/O connections 38B′ of the adapter 38′. With such connection, the user interfacing device 36′ may communicate with the user initiable microcontroller 22 via the adapter 38′.

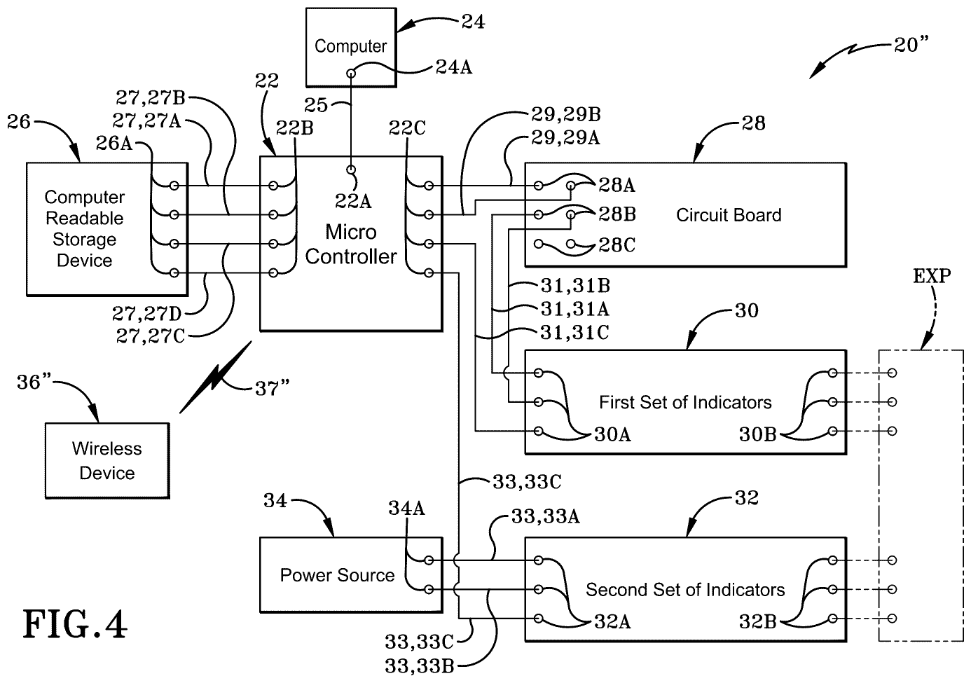

In yet another alternative embodiment, user initiable microcontroller 22 may be configured to operably connect with a wireless user interfacing device or wireless device 36″ via wireless capabilities (see FIG. 4) via a wireless connection 37″. In this embodiment, any suitable wireless device (e.g., computer, tablet, phone, and other suitable wireless devices of the like) may electrically connect with the user initiable microcontroller 22 that includes wireless communication hardware and protocols that match with wireless communication hardware and protocols of the wireless device. In one example, user initiable microcontroller 22 may use a variety of protocols (e.g., Wifi, ZigBee, MiWi, Bluetooth) for communication with the wireless device 36″. In another example, user initiable microcontroller 22 may have its own IP address and may communicate directly with a router or gateway which is accessible to the wireless device 36″. This would typically be the case if the communication protocol is WiFi.

It should be appreciated that identification system 20 may be used in any suitable mass storage environment or facility for swiftly indicating a specific bay defined in a specific shelving unit and identifying a selected item 2. In one instance, identification system 20 may be used with shelving unit 10 described and illustrated herein for swiftly indicating a specific bay in the set of bays 10F defined in the shelving unit 10 and identifying a selected item 2. In this instance, the identification system 20 would be designed and/or integrated into the shelving unit 10 such that the shelving unit 10 and the identification system 20 is a singular apparatus. In another instance, identification system 20 may be used with a preexisting, commercially available shelving unit for swiftly indicating a specific bay in a set of bays defined in the preexisting shelving unit and identifying a selected item. In this instance, the identification system 20 would be retrofitted into the preexisting shelving unit.

Having now described the systems and components of mass storage system 1, methods of using the mass storage system 1 to swiftly indicate and identify a selected item 2 are described in more detail below.

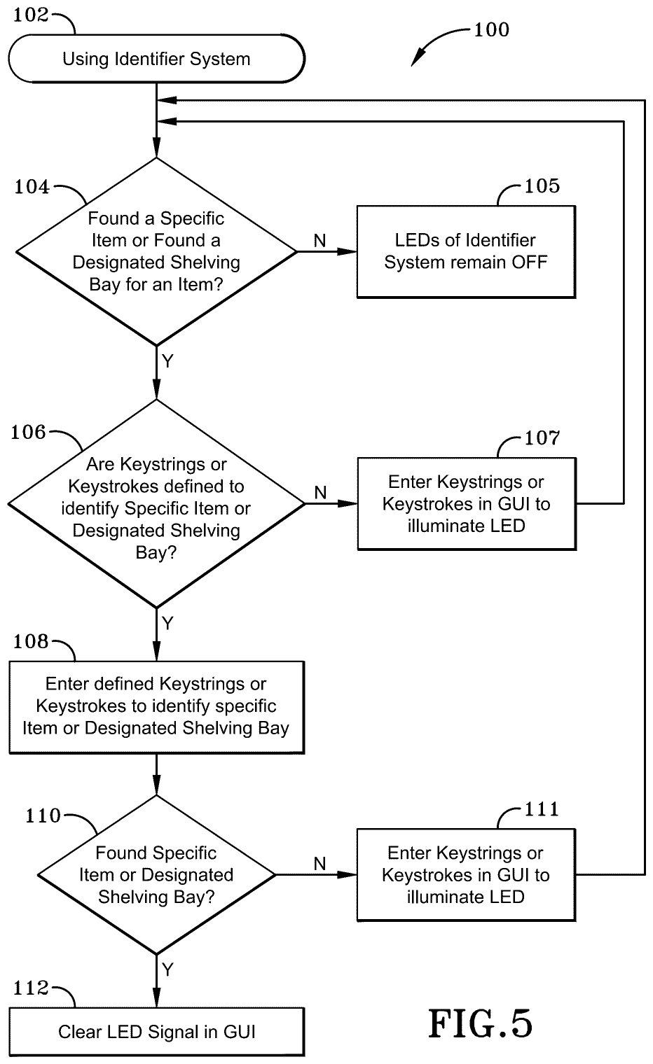

Prior to use, a set of instructions or identification protocol 100 may be preloaded onto the computer readable storage device 26, via the external computer 24, so that the user initiable microcontroller 22 may access and execute the identification protocol 100. Once loaded, user initiable microcontroller 22 is then enabled to identify specific items 2 by automatically indicating specific bays in the set of bays 10F defined in the shelving units 10. Such identification protocol 100 is best seen in FIG. 5.

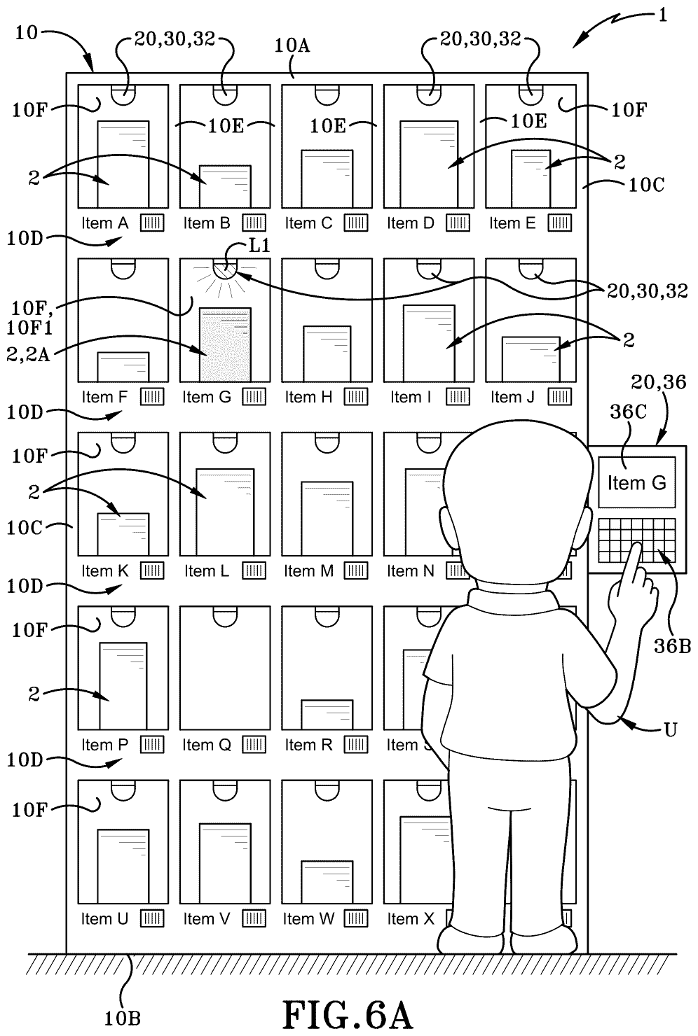

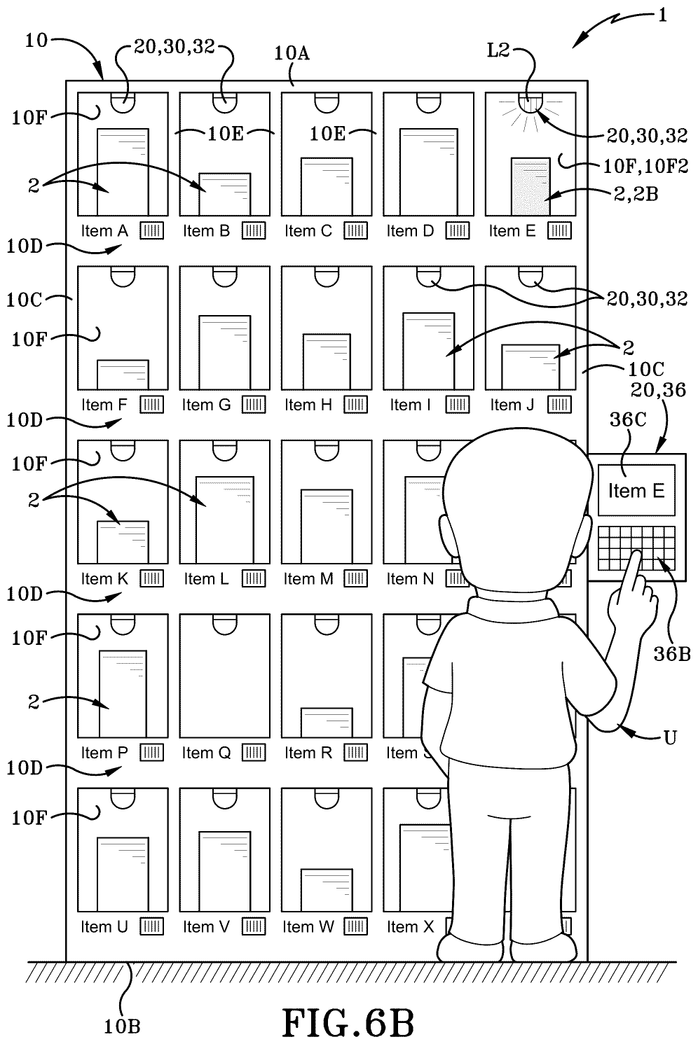

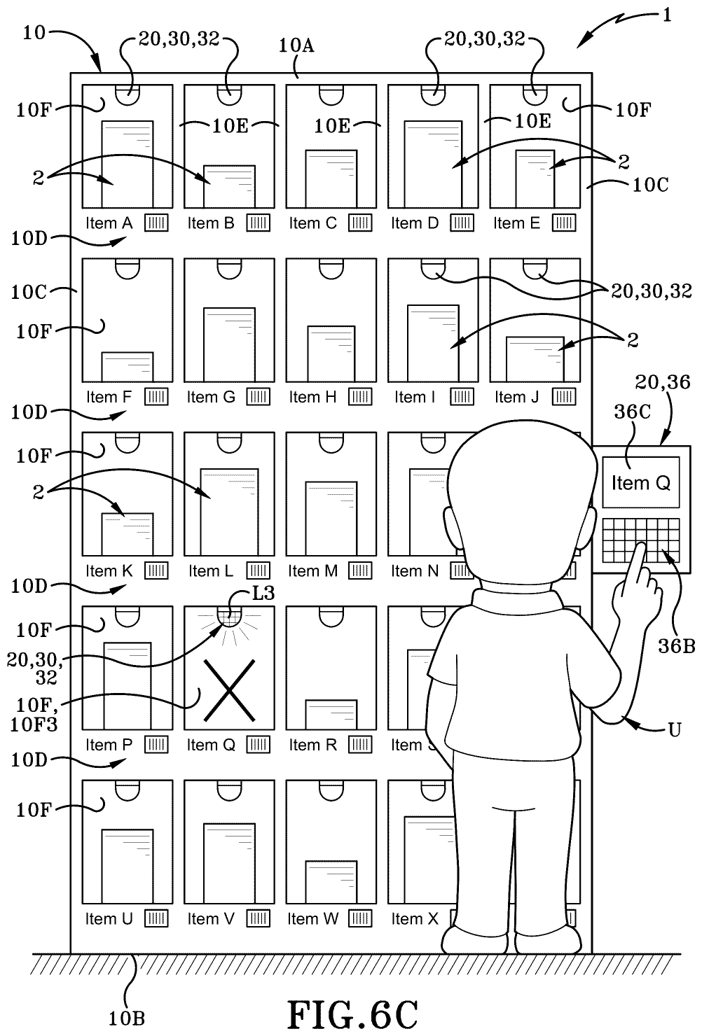

Initially, an initial step 102 of identification protocol 100 may be taken by user (denoted by reference letter “U” in FIGS. 6A-6C) by simply initiating use of the identification system 20. Once initiated, another step 104 of identification protocol 100 may be taken by user where the user may use identification system 20 to find a specific item 2 or a specific bay of the set of bays 10F defined in the shelving unit 10 for an item 2. If, however, user does not desire to find a specific item or a designated shelving bay for an item, the identification system 20 remains in an OFF state unless initiated by user (see step 105 of identification protocol 100).

Once user has initiated the identification system 20 (i.e., completed step 104), another step 106 of identification protocol 100 may be taken by user by entering at least one identification code into the identification system 20 to identify and indicate a specific item 2 or a specific bay of the set of bays 10F defined in the shelving unit 10 the user is looking for. If the item 2 includes a designated identification code, user may then proceed to step 108 of identification protocol 100 where the user may simply enter the at least one identification code as a keystring or a keystroke into the user interfacing device 36, via the keypad 36B, to enable the identification system 20 to indicate a specific item 2 or a specific bay of the set of bays 10F defined in the shelving unit 10 the user is looking for. The item 2 may include a designated identification code in identification system 20 due to the external computer 24 relaying such information to one or both of the user initiable microcontroller 22 and computer readable storage device 26 when the item 2 was originally stocked or stored in the shelving unit 10.

If, however, a designated identification code is not provided for item 2, step 109 of identification protocol 100 may be utilized by user to assign and/or designate an identification code to item 2 so that such item 2 can be indicated by identification system 20. Such step 109 may be initiated by user when user is stocking or storing the item 2 in the shelving unit 10 (see FIG. 6C). This assignment or designation of an identification code for an item may be saved to the computer readable storage device 26 for future identification use.

Once the designated identification code has been entered into user interfacing device 36 (step 108), identification system 20 then begins indicating and locating the item 2 for user. At this point, the user interfacing device 36 relays such information to the user initiable microcontroller 22. Once received, the user initiable microcontroller 22 then utilizes the computer readable storage device 26 to determine which bay of the set of bays 10F defined in the shelving unit 10 is storing the item 2. Once the specific bay of the set of bays 10F is identified from the computer readable storage device 26, the user initiable microcontroller 22 may then relay at least one signal to one or both of the first set of indicators 30 and the second set of indicators 32 to indicate the specific bay of the set of bays 10F storing the item 2.

As discussed above, indicators of the first set of indicators 30 are housed inside of the bays of the set of bays 10F defined in the shelving unit 10 so that a specific indicator of the first set of indicators 30 may be used to automatically indicate the specific bay of the set of bays 10F (see FIG. 6A-6C). Similarly, indicators of the second set of indicators 32 are also housed inside of the bays of the set of bays 10F defined in the shelving unit 10 so that a specific indicator of the second set of indicators 32 may also be used to automatically indicate the specific bay of the set of bays 10F (see FIG. 6A-6C).

While the first set of indicators 30 and the second set of indicators 32 are used to indicate a specific bay of the set of bays 10F storing a selected item 2, the first set of indicators 30 and the second set of indicators 32 may also indicate to the user specific logistic information for item 2. In one example, a first indicator of one or both of the first set of indicators 30 and the second set of indicators 32 may indicate a first logistic indication (denoted with reference letter “L1”) to the user (as best seen in FIG. 6A). In this example, the first logistic indictor may signify a first payment state of item 2A stored inside a first bay 10F1 of the set of bays 10F in which item 2A has been paid by a customer. In another example, a second indicator of one or both of the first set of indicators 30 and the second set of indicators 32 may indicate a second logistic indication (denoted with reference letter “L2”) to the user (as best seen in FIG. 6B); the second logistic indication is different than the first logistic indication mentioned above. In this example, the second logistic indictor may signify a second payment state of item 2B stored inside a second bay 10F2 of the set of bays 10F in which payment of the item 2 is outstanding for a customer. In another example, an indicator of one or both of the first set of indicators 30 and the second set of indicators 32 may indicate a third logistic indication (denoted with reference letter “L3”) to the user (as best seen in FIG. 6C); the third logistic indication is different than the first logistic indication and the second logistic indication mentioned above. In this example, the third logistic indictor may signify a third state of an item stored inside a third bay 10F3 of the set of bays 10F in which item is unavailable or out of stock (denoted by an “X” in the third bay 10F3).

In the examples described above, the first logistic indication, the second logistic indication, and the third logistic indication performed by one or both of the first set of indicators 30 and the second set of indicators 32 may be any suitable indication described herein. As seen in FIGS. 6A-6C, indicator of one or both of the first set of indicators 30 and the second set of indicators 32 visually indicate and/or illuminate a specific bay of the set of bays 10F storing a selected item 2. With respect to FIG. 6A, the indicator of one or both of the first set of indicators 30 and the second set of indicators 32 visually indicates and/or illuminates the first logistic indication as a first color or hue. Similarly, with respect to FIG. 6B, the indicator of one or both of the first set of indicators 30 and the second set of indicators 32 visually indicates and/or illuminates the second logistic indication as a second color or hue that is different than the first color or hue shown in FIG. 6A. Similarly, with respect to FIG. 6B, the indicator of one or both of the first set of indicators 30 and the second set of indicators 32 visually indicates and/or illuminates the third logistic indication as a third color or hue that is different than the first color or hue shown in FIG. 6A and the second color or hue shown in FIG. 6B.

Once the user finds the designated bay of the set of bays 10F and/or the item 2, the user may then clear and/or cease the logistic indication emitted by the indicator of one or both of the first set of indicators 30 and the second set of indicators 32 (step 112 of identification protocol 100). Such clear and/or cease of the logistic indication may be performed by the user inputting a keystring or keystroke to remove this logistic indication from the identification system 20. As such, this logistic indication is removed from the computer readable storage device 26 for the specific bay of the set of bays 10F that was storing the item 2. If desired, user may then rewrite and/or reprogram this specific bay with a new identification code when a new item or product is stored in this specific bay.

If, however, the designated identification code entered into the user interfacing device 36 is incorrect for item 2 (e.g., incorrect bay of the set of bays 10F is indicated), step 111 of identification protocol 100 may then be utilized by user to reassign and/or redesignate an identification code to item 2 so that such item 2 can be indicated by identification system 20. Such step 111 may be initiated by user when the incorrect item 2 is indicated to the user during an identification operation.

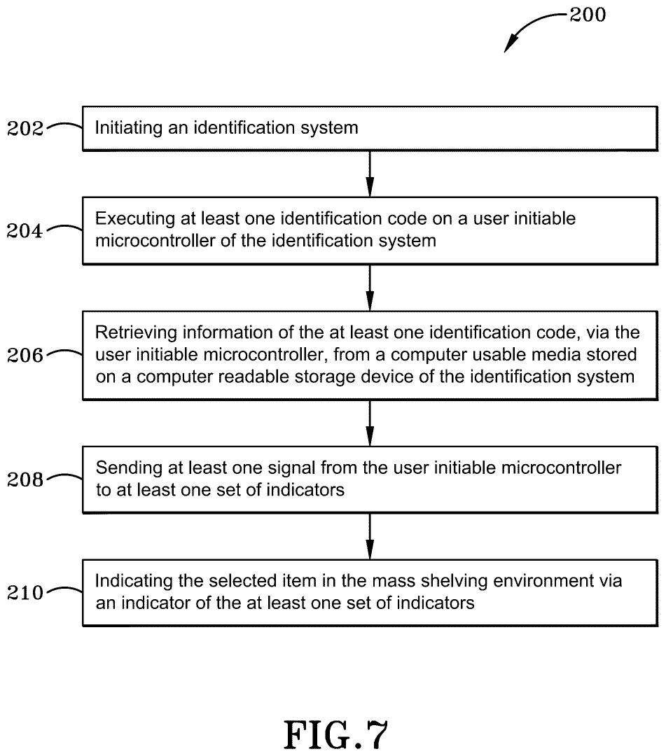

FIG. 7 illustrates a method 200 of indicating a selected item in a mass shelving environment. An initial step 202 of method 200 may include initiating an identification system of the mass shelving environment. Another step 204 of method 200 may include executing at least one identification code on a user initiable microcontroller of the identification system. Another step 206 of method 200 may include retrieving information of the at least one identification code, via the user initiable microcontroller, from a computer usable media stored on a computer readable storage device of the identification system. Another step 208 of method 200 may include sending at least one signal from the user initiable microcontroller to at least one set of indicators. Another step 210 of method 200 may include indicating the selected item in the mass shelving environment via an indicator of the at least one set of indicators.

Optional steps and/or additional steps may be provided with method 200 for indicating a selected item in a mass shelving environment. Optionally, the step of indicating the selected item in the mass shelving environment via the indicator of the at least one set of indicators further includes that the selected item in the mass shelving environment is visually indicated by the indicator of the at least one set of indicators. An optional step of method 200 may further include emitting a first logistic indication, via the indicator of the at least one set of indicators, in response to the at least one identification code executed on the user initiable microcontroller; and wherein the first logistic indication denotes that a first payment state of the selected item. An optional step of method 200 may further include emitting a second logistic indication, via the indicator of the at least one set of indicators, in response to the at least one identification code executed on the user initiable microcontroller; wherein the second logistic indication denotes that a second payment state of the selected item different than the first payment state denoted by the first logistic indication. An optional step of method 200 may further include inputting the at least one identification code on the user initiable microcontroller via a user interfacing device of the identification system. An optional step of method 200 may further include connecting the user interfacing device with the user initiable microcontroller by one of a wired connection or a wireless connection. An optional step of method 200 may further include itemizing each item from a predetermined amount of items stored in the plurality of shelving units by an external computer of the identification system. Optional steps of method 200 may further include sending the at least one signal from the user initiable microcontroller to at least another set of indicators of the identification system; and indicating the selected item in the mass shelving environment via an indicator of the at least another set of indicators. Optionally, method 200 may further include that the selected item is positioned between the at least one set of indicators and the at least another set of indicators. An optional step of method 200 may further include powering to the at least one set of indicators and the at least another set of indicators via a power source of the identification system.

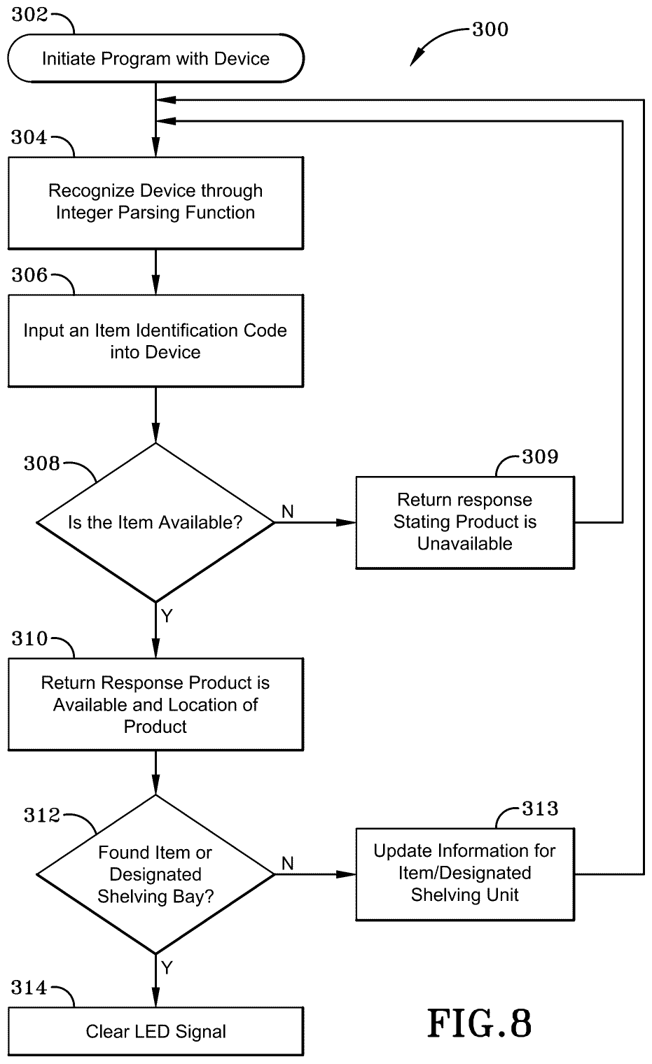

FIG. 8 illustrates another set of instructions or identification protocol 300 that may be accessed and executable by the user initiable microcontroller 22 of the identification system 20. Prior to use, the identification protocol 300 is preloaded onto the computer readable storage device 26 and is accessible by the user initiable microcontroller 22 to assist users or workers with identifying specific items 2 by automatically indicating specific bays in the set of bays 10F defined in the shelving units 10. It should also be noted that while identification protocol 300 may be loaded to computer readable storage device 26 along with identification protocol 100, identification protocol 300 includes different steps and/or instructions for assisting users or workers with identifying specific items 2; such steps and/or instructions of identification protocol 300 are now discussed in greater detail below.

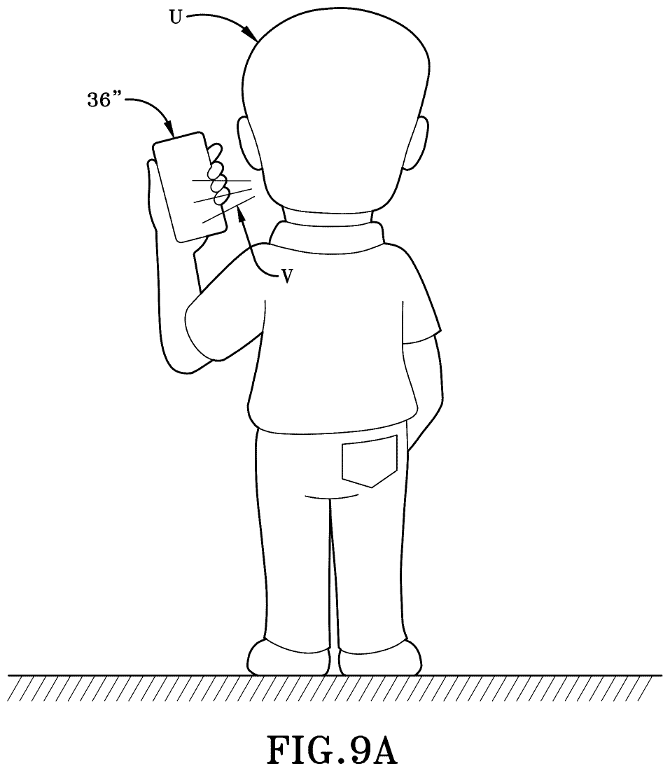

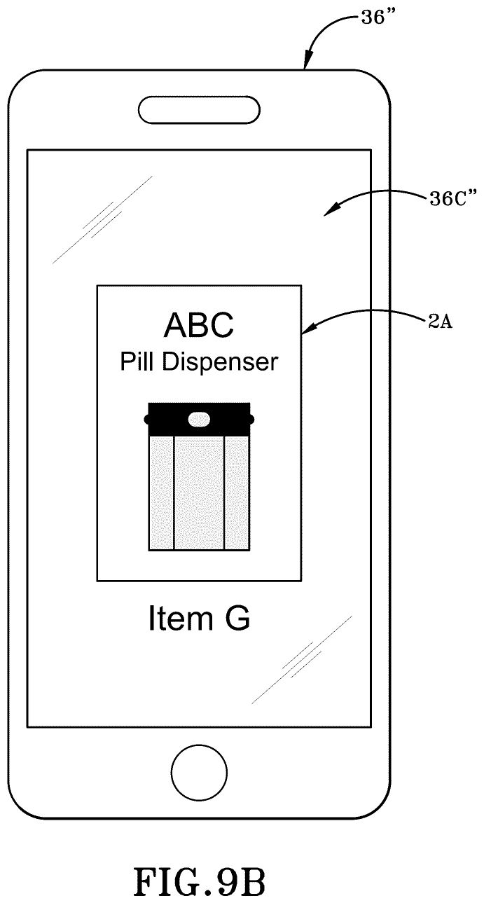

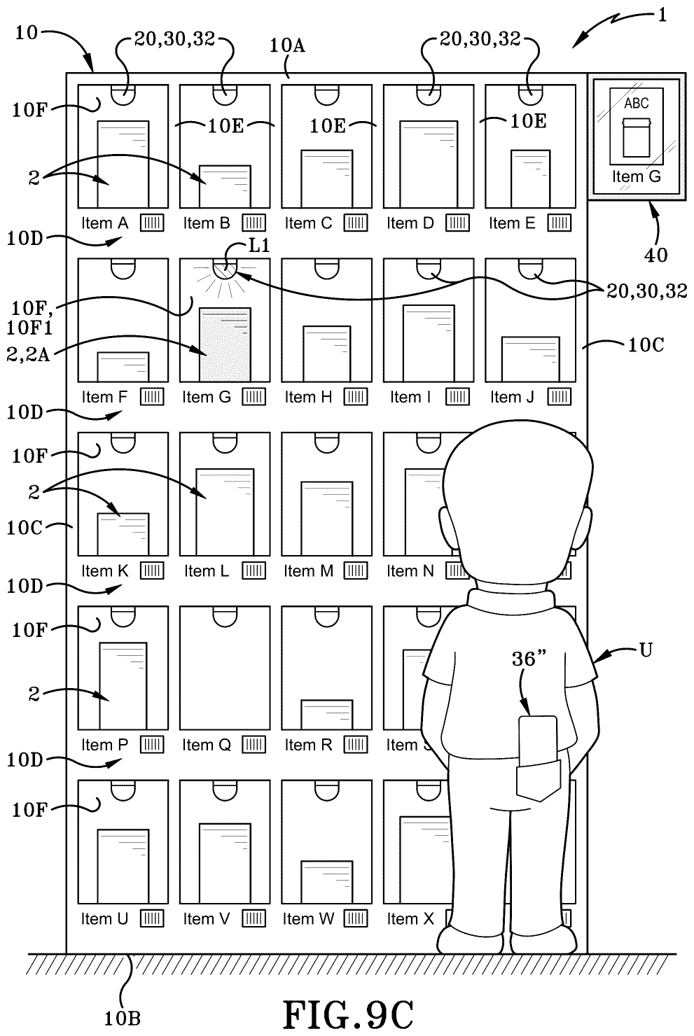

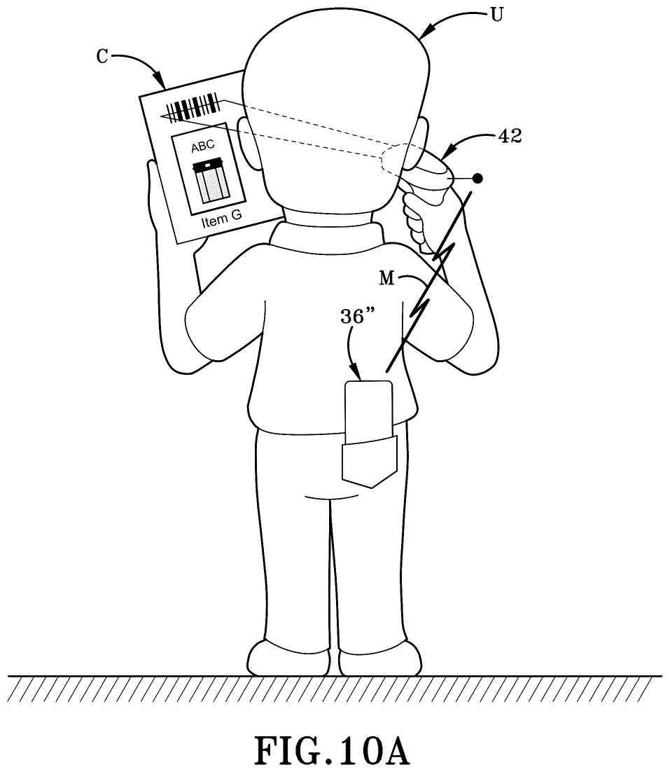

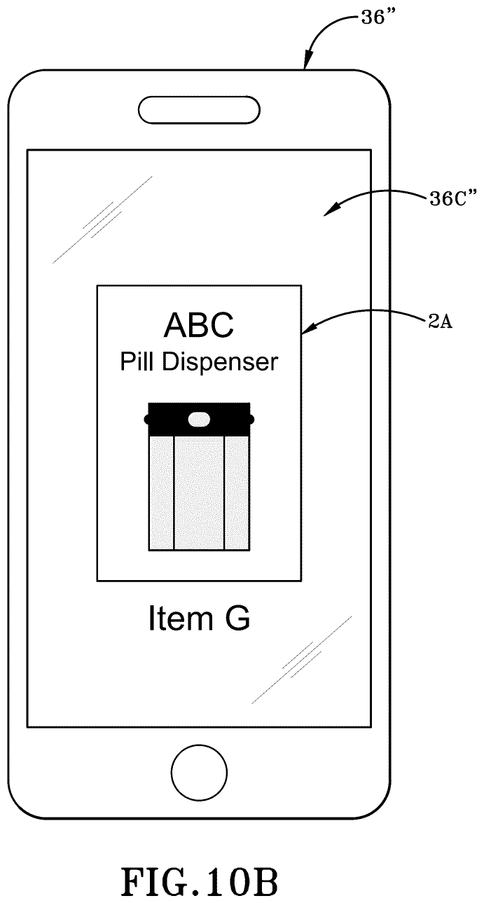

Initially, an initial step 302 of identification protocol 300 may be taken by user (denoted by reference letter “U” in FIGS. 9A-9C and 10A-10B) by simply initiating use of a connected user interfacing device 36, 36′, 36″ of identification system 20. As best seen in FIG. 9A, user initiates operation of the user interfacing device 36″ (i.e., a wireless device such as a smartphone or other suitable wirelesses devices mentioned herein) which is currently in operative communication with the identification system 20 and is configured to access the identification protocol 300. While not illustrated herein, other users may initiate similar devices to accomplish step 302 of identification protocol 300.

Once initiated, another step 304 of identification protocol 300 may be accomplished when user initiable microcontroller 22 recognizes the user interfacing device 36″. In the present disclosure, step 304 of identification protocol 300 includes an integer parsing function wherein the user initiable microcontroller 22 is configured to apply at least one numerical value to the user interfacing device 36″ upon execution of the step 304. The numerical value applied to the user interfacing device 36″ is considered advantageous in this embodiment because the user initiable microcontroller 22 differentiates the user interfacing device 36″ from other user interfacing devices that are connected to the user initiable microcontroller 22. Once the user interfacing device 36″ is numbered, the user interfacing device 36″ is then configured to send or output data through serial to the user initiable microcontroller 22 and other devices provided in identification system 20 to identify one or more items 2. It should be noted that other devices mentioned herein (including user interfacing devices 36, 36′) are provided numerical values as well upon execution of the identification protocol 300.

Once the user interfacing device 36″ is recognized by user initiable microcontroller 22, another step 306 of identification protocol 300 may be accomplished by user entering or inputting at least one identification code into the identification system 20 to identify and indicate a specific item 2 or a specific bay of the set of bays 10F defined in the shelving unit 10 the user is looking for. As best seen in FIG. 9A, user inputs at least one voice or vocal command into the user interfacing device 36″ to identify and indicate a specific item 2a or a specific bay of the set of bays 10F defined in the shelving unit 10 the user is looking for; such voice input made by user is denoted by lines labeled “V” in FIG. 9A. It should be understood that onboard and/or preexisting equipment provided with the user interfacing device 36″ (e.g., microphone, keypad, keyboard, camera, and other available equipment or hardware provided with the user interfacing device 36″) may be used when the user inputs at least one command to the user interfacing device 36″.

Still referring to step 306, other exemplary inputs may be performed by a user to identify and indicate a specific item 2 or a specific bay of the set of bays 10F defined in the shelving unit 10 the user is looking for. In one alternative embodiment, and as best seen in FIG. 10A, user may scan a barcode or identification code off of a tangible medium (e.g., a catalog, spreadsheet, or similar tangible medium that includes such codes) by a preexisting scanning device 42. In this alternative embodiment, the preexisting scanning device 42 is an optical scanner, barcode scanner, or similar device that enables a user to scan one or more types of identification codes that stores data for specific items and/or products. It should be noted that when the preexisting scanning device 42 is used, the preexisting scanning device 42 is also configured to send or output data to the user interfacing device 36″ (or other connected user interfacing devices 36, 36′) based on the preexisting scanning device 42 being given a numerical value based on step 304. Such transfers of data from the preexisting scanning device 42 to the user interfacing device 36″ is denoted by a symbol labeled “M” in FIG. 10A.

Once the third step 306 is performed, another step 308 is accomplished by the user initiable microcontroller 22 by determining if the item 2A, inputted by the user at the third step 306, is available. If the item 2A is unavailable, the user initiable microcontroller 22 executes and accomplishes step 309 by returning a response stating that the product or item 2A is unavailable. If the item 2A is available, the user initiable microcontroller 22 executes and accomplishes step 310 by returning a response stating that the product or item 2A is available. Upon such execution of step 310, the user initiable microcontroller 22 may also provide additional data relating to the item 2A such as the location of the item 2A, a brand or product name of the item 2A, a description of the item 2A, and other data that may relate to the item 2A. As best seen in FIG. 9B, a screen 36C″ of the user interfacing device 36″ may return such information so that the user understand the item 2A is available along with other useful information such as the location of the item 2A, a brand or product name of the item 2A, a description of the item 2A, and other data that may relate to the item 2A.

Similar to the identification system 20 executing identification protocol 100, identification system 20 may also utilize other devices provided in the identification system 20 to automatically identify to the location of the item 2A. As the designated identification code is inputted into user interfacing device 36″, identification system 20 then begins indicating and locating the item 2A for user. At this stage, the user initiable microcontroller 22 then utilizes the computer readable storage device 26 to determine which bay of the set of bays 10F defined in the shelving unit 10 is storing the item 2. Once the specific bay of the set of bays 10F is identified from the computer readable storage device 26, the user initiable microcontroller 22 may then relay at least one signal to one or both of the first set of indicators 30 and the second set of indicators 32 to indicate the specific bay of the set of bays 10F storing the item 2.

Upon execution of step 310, one or more auxiliary monitors or screens 42 of identification system 20 may display information about item 2A. As best seen in FIG. 9C, at least one auxiliary monitor 42 that is mounted to at least one shelving unit 10 displays information relating to the item 2A inputted and/or entered by the user. Such information displayed by the auxiliary monitor 42 may be similar to the information displayed on the screen 36C″ of the user interfacing device 36″. Such inclusion of one or more auxiliary monitors 42 may provide additional assistance to users when trying to find a specific product or item that is stored inside a specific bay 10F of a specific shelving unit 10.

As discussed above, indicators of the first set of indicators 30 are housed inside of the bays of the set of bays 10F defined in the shelving unit 10 so that a specific indicator of the first set of indicators 30 may be used to automatically indicate the specific bay of the set of bays 10F (see FIG. 9C.). Similarly, indicators of the second set of indicators 32 are also housed inside of the bays of the set of bays 10F defined in the shelving unit 10 so that a specific indicator of the second set of indicators 32 may also be used to automatically indicate the specific bay of the set of bays 10F (see FIG. 9C). While the first set of indicators 30 and the second set of indicators 32 are used to indicate a specific bay of the set of bays 10F storing a selected item 2, the first set of indicators 30 and the second set of indicators 32 may also indicate to the user specific logistic information for item 2 when identification protocol 300 is executed. Such examples of logistic information being visually indicated by the first set of indicators 30 and the second set of indicators 32 is discussed above and shown in FIGS. 6A-6C.

Once the user finds the designated bay of the set of bays 10F and/or the item 2A (step 312 of identification protocol 300), the user may then clear and/or cease the logistic indication emitted by the indicator of one or both of the first set of indicators 30 and the second set of indicators 32 (step 314 of identification protocol 300). Such clear and/or cease of the logistic indication may be performed by the user inputting a command or keystroke to remove this logistic indication from the identification system 20. As such, this logistic indication is removed from the computer readable storage device 26 for the specific bay of the set of bays 10F that was storing the item 2. If desired, user may then rewrite and/or reprogram this specific bay with a new identification code when a new item or product is stored in this specific bay (similar to identification protocol 100).

If, however, the designated identification code entered into the user interfacing device 36 is incorrect for item 2 (e.g., incorrect bay of the set of bays 10F is indicated), step 313 of identification protocol 300 may then be utilized by user to reassign and/or update an identification code to item 2A so that such item 2A can be indicated by identification system 20. Such step 313 may be initiated by user when the incorrect item 2 is indicated to the user during an identification operation.

It should be understood that identification protocol 300 may include and/or utilize one or more steps discussed in identification protocol 100. In one exemplary embodiment, identification protocol 300 may include step 106 in that a user may enter at least one identification code into the identification system 20 to identify and indicate a specific item 2 or a specific bay of the set of bays 10F defined in the shelving unit 10 the user is looking for. In this exemplary embodiment, the user may simply enter the at least one identification code as a keystring or a keystroke into a user interfacing device, via a keypad, to enable the identification system to indicate a specific item or a specific bay of a set of bays defined in a shelving unit the user is looking for. In another exemplary embodiment, identification protocol 300 may include steps 107 and 111 for reassigning or updating identification codes for specific items or products.

The system of the present disclosure may additionally include one or more sensors to sense or gather data pertaining to the surrounding environment or operation of the system. Some exemplary sensors capable of being electronically coupled with the system of the present disclosure (either directly connected to the system of the present disclosure or remotely connected thereto) may include but are not limited to: accelerometers sensing accelerations experienced during rotation, translation, velocity/speed, location traveled, elevation gained; gyroscopes sensing movements during angular orientation and/or rotation, and rotation; altimeters sensing barometric pressure, altitude change, terrain climbed, local pressure changes, submersion in liquid; impellers measuring the amount of fluid passing thereby; Global Positioning sensors sensing location, elevation, distance traveled, velocity/speed; audio sensors sensing local environmental sound levels, or voice detection; Photo/Light sensors sensing ambient light intensity, ambient, Day/night, UV exposure; TV/IR sensors sensing light wavelength; Temperature sensors sensing machine or motor temperature, ambient air temperature, and environmental temperature; and Moisture Sensors sensing surrounding moisture levels.

If sensors are utilized to gather data relating to the system of the present disclosure, then sensed data may be evaluated and processed with artificial intelligence (AI). Analyzing data gathered from sensors using artificial intelligence involves the process of extracting meaningful insights and patterns from raw sensor data to produce refined and actionable results. Raw data is gathered from various sensors, for example those which have been identified herein or others, capturing relevant information based on the intended analysis. This data is then preprocessed to clean, organize, and structure it for effective analysis. Features that represent key characteristics or attributes of the data are extracted. These features serve as inputs for AI algorithms, encapsulating relevant information essential for the analysis. A suitable AI model, such as machine learning or deep learning (regardless of whether it is supervised or unsupervised), is chosen based on the nature of the data and the desired analysis outcome. The model is then trained using labeled or unlabeled data to learn the underlying patterns and relationships. The model is fine-tuned and optimized to enhance its performance and accuracy. This process involves adjusting parameters, architectures, and algorithms to achieve better results. The trained model is used to make predictions or inferences on new, unseen data. The model processes the extracted features and generates refined output based on the patterns it has learned during training. The results produced by the AI model are refined through post-processing techniques to ensure accuracy and relevance. These refined results are then interpreted to extract meaningful insights and derive actionable conclusions. Feedback from the refined results is used to improve the AI model iteratively. The process involves incorporating new data, adjusting the model, and enhancing the analysis based on real-world feedback and evolving requirements. Further, AI results can be used to alter the operation of the system of the present disclosure based on feedback. For example, AI feedback can be used to improve the efficiency of the system of the present disclosure by responding to predicted changes in the environment or predicted changes to the system of the present disclosure more quickly than if only sensed by one or more of the sensors.

The system of the present disclosure may include wireless communication logic coupled to sensors on the system. The sensors gather data and provide the data to the wireless communication logic. Then, the wireless communication logic may transmit the data gathered from the sensors to a remote device. Thus, the wireless communication logic may be part of a broader communication system, in which one or several devices, assemblies, or systems of the present disclosure may be networked together to report alerts and, more generally, to be accessed and controlled remotely. Depending on the types of transceivers installed in the system of the present disclosure, the system may use a variety of protocols (e.g., Wi-Fi®, ZigBee®, MIWI, BLUETOOTH®) for communication. In one example, each of the devices, assemblies, or systems of the present disclosure may have its own IP address and may communicate directly with a router or gateway. This would typically be the case if the communication protocol is Wi-Fi®. (Wi-Fi® is a registered trademark of Wi-Fi Alliance of Austin, TX, USA; ZigBee® is a registered trademark of ZigBee Alliance of Davis, CA, USA; and BLUETOOTH® is a registered trademark of Bluetooth Sig, Inc. of Kirkland, WA, USA).

In another example, a point-to-point communication protocol like MiWi or ZigBee® is used. One or more of the system of the present disclosure may serve as a repeater, or the devices, assemblies, or systems of the present disclosure may be connected together in a mesh network to relay signals from one system to the next. However, the individual system in this scheme typically would not have IP addresses of their own. Instead, one or more of the devices, assemblies, or system of the present disclosure communicates with a repeater that does have an IP address, or another type of address, identifier, or credential needed to communicate with an outside network. The repeater communicates with the router or gateway.

In either communication scheme, the router or gateway communicates with a communication network, such as the Internet, although in some embodiments, the communication network may be a private network that uses transmission control protocol/internet protocol (TCP/IP) and other common Internet protocols but does not interface with the broader Internet, or does so only selectively through a firewall.

The system that receives and processes signals from the system of the present disclosure may differ from embodiment to embodiment. In one embodiment, alerts and signals from the system of the present disclosure are sent through an e-mail or simple message service (SMS; text message) gateway so that they can be sent as e-mails or SMS text messages to a remote device, such as a smartphone, laptop, or tablet computer, monitored by a responsible individual, group of individuals, or department, such as a maintenance department. Thus, if a particular system of the present disclosure creates an alert because of a data point gathered by one or more sensors, that alert can be sent, in e-mail or SMS form, directly to the individual responsible for fixing it. Of course, e-mail and SMS are only two examples of communication methods that may be used; in other embodiments, different forms of communication may be used.

In other embodiments, alerts and other data from the sensors on the system of the present disclosure may also be sent to a work tracking system that allows the individual, or the organization for which he or she works, to track the status of the various alerts that are received, to schedule particular workers to repair a particular system of the present disclosure, and to track the status of those repair jobs. A work tracking system would typically be a server, such as a Web server, which provides an interface individuals and organizations can use, typically through the communication network. In addition to its work tracking functions, the work tracker may allow broader data logging and analysis functions. For example, operational data may be calculated from the data collected by the sensors on the system of the present disclosure, and the system may be able to provide aggregate machine operational data for a system of the present disclosure or group of devices, assemblies, or systems of the present disclosure.

The system also allows individuals to access the system of the present disclosure for configuration and diagnostic purposes. In that case, the individual processors or microcontrollers of the system of the present disclosure may be configured to act as Web servers that use a protocol like hypertext transfer protocol (HTTP) to provide an online interface that can be used to configure the system. In some embodiments, the systems may be used to configure several devices, assemblies, or systems of the present disclosure at once. For example, if several devices, assemblies, or systems are of the same model and are in similar locations in the same location, it may not be necessary to configure the devices, assemblies, or systems individually. Instead, an individual may provide configuration information, including baseline operational parameters, for several devices, assemblies, or systems at once.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, or a combination thereof. When implemented in software, the software code or instructions can be executed on any suitable processor or collection of processors, whether provided in a single computer or distributed among multiple computers. Furthermore, the instructions or software code can be stored in at least one non-transitory computer readable storage device.

Also, a computer or smartphone may be utilized to execute the software code or instructions via its processors may have one or more input and output devices. These devices can be used, among other things, to present a user interfacing. Examples of output devices that can be used to provide a user interfacing include printers or display screens for visual presentation of output and speakers or other sound generating devices for audible presentation of output. Examples of input devices that can be used for a user interfacing include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage device (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic”, as used herein, includes but is not limited to hardware, firmware, software, and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve on existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +//−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, this term was included as required by the formatting requirements of word document submissions pursuant to MPEP guidelines/requirements and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed:

1. An identification system for a mass storage system, comprising:
a user initiable microcontroller;
a computer readable storage device in logical communication with the user initiable microcontroller and configured to store a computer usable media for indicating any item from a predetermined amount of items stored in a plurality of shelving units; and
at least one set of indicators electrically connected with the user initiable microcontroller and operably engaged with each shelf of a shelving unit of the plurality of shelving units;
wherein the user initiable microcontroller is configured to automatically indicating the at least one location of a selected item, via the at least one set of indicators, in any shelving unit of the plurality of shelving units in response to at least one identification code executed on the user initiable microcontroller.

2. The identification system of claim 1, wherein the at least one set of indicators is configured to automatically visually indicate at least one location of the selected item in any shelving unit of the plurality of shelving units in response to the at least one identification code executed on the user initiable microcontroller.

3. The identification system of claim 1, wherein the at least one set of indicators comprises:
a first logistic indication in response to the at least one identification code executed on the user initiable microcontroller;
wherein the first logistic indication signifies a first payment state of the selected item.

4. The identification system of claim 3, wherein the at least one set of indicators further comprises:
a second logistic indication in response to at least another identification code executed on the user initiable microcontroller;
wherein the second logistic indication signifies a second payment state of the selected item different than the first payment state indicated by the first logistic indication.

5. The identification system of claim 1, further comprising:
a user interfacing device electrically connected with the user initiable microcontroller;
wherein the user interfacing device is configured for executing the at least one identification code on the user initiable microcontroller to automatically indicate the at least one location of the selected item in any shelving unit of the plurality of shelving units.

6. The identification system of claim 5, wherein the user interfacing device is electrically connected with the user initiable microcontroller via a wired connection or a wireless connection.

7. The identification system of claim 1, further comprising:
an external computer in logical communication with the user initiable microcontroller;
wherein the external computer is configured to store a second computer usable media for itemizing each item from the predetermined amount of items stored in the plurality of shelving units.

8. The identification system of claim 1, further comprising:
at least another set of indicators electrically connected with the microcontroller and operably engaged with each shelf of a shelving unit of the plurality of shelving units;
wherein the user initiable microcontroller is configured to automatically indicate the at least one location of the selected item, via the at least another set of indicators, in any shelving unit of the plurality of shelving units in response to the at least one identification code executed on the user initiable microcontroller.

9. The identification system of claim 8, wherein each item of the predetermined amount of items is positioned between the at least one set of indicators and the at least another set of indicators.

10. The identification system of claim 8, further comprising:
a power source electrically connected with one of the at least one set of indicators and the at least another set of indicators for providing electrical power to the at least one set of indicators and the at least another set of indicators.

11. A method of indicating a selected item in a mass shelving environment, the method comprising:
initiating an identification system of the mass shelving environment;
executing at least one identification code on a user initiable microcontroller of the identification system;
retrieving information of the at least one identification code, via the user initiable microcontroller, from a computer usable media stored on a computer readable storage device of the identification system;
sending at least one signal from the user initiable microcontroller to at least one set of indicators; and
indicating the selected item in the mass shelving environment via an indicator of the at least one set of indicators.

12. The method of claim 11, wherein the step of indicating the selected item in the mass shelving environment via the indicator of the at least one set of indicators further includes that the selected item in the mass shelving environment is visually indicated by the indicator of the at least one set of indicators.

13. The method of claim 11, further comprising:
emitting a first logistic indication, via the indicator of the at least one set of indicators, in response to the at least one identification code executed on the user initiable microcontroller;
wherein the first logistic indication denotes that a first payment state of the selected item.

14. The method of claim 13, further comprising:
emitting a second logistic indication, via the indicator of the at least one set of indicators, in response to the at least one identification code executed on the user initiable microcontroller;
wherein the second logistic indication denotes that a second payment state of the selected item different than the first payment state denoted by the first logistic indication.

15. The method of claim 11, further comprising:
inputting the at least one identification code on the user initiable microcontroller via a user interfacing device of the identification system.

16. The method of claim 15, further comprising:
connecting the user interfacing device with the user initiable microcontroller by one of a wired connection or a wireless connection.

17. The method of claim 11, further comprising:
itemizing each item from a predetermined amount of items stored in the plurality of shelving units by an external computer of the identification system.

18. The method of claim 11, further comprising:
sending the at least one signal from the user initiable microcontroller to at least another set of indicators of the identification system; and
indicating the selected item in the mass shelving environment via an indicator of the at least another set of indicators.

19. The method of claim 18, wherein the selected item is positioned between the at least one set of indicators and the at least another set of indicators.

20. The identification system of claim 18, further comprising:
powering to the at least one set of indicators and the at least another set of indicators via a power source of the identification system.
